(19) United States
(12) Patent Application Publication
(10) Pub. No.: US 2024/0419495 A1
(43) Pub. Date: Dec. 19, 2024

(54) INFORMATION PROCESSING DEVICE, INFORMATION PROCESSING METHOD, AND PROGRAM

(71) Applicant: NS Solutions Corporation, Tokyo (JP)

(72) Inventor: Hideki KOHNO, Tokyo (JP)

(21) Appl. No.: 18/740,280

(22) Filed: Jun. 11, 2024

(30) Foreign Application Priority Data
Jun. 15, 2023 (JP) 2023-098484

(51) Int. Cl. G06F 9/50

(52) U.S. Cl. CPC G06F 9/5027

(57) ABSTRACT

An information processing device includes: a receiver configured to receive, via a network, a request pertaining to executing a series of processes defined in such a manner that one or more first processing units are arranged to be sequentially executed; an updater configured to update the series of processes by adding a second processing unit based on contents of the received request to a timing in the series of processes based on the contents of the request; and a processor configured to execute the series of processes updated by the updater.

### CROSS-REFERENCE TO RELATED APPLICATIONS

This application is based upon and claims the benefit of priority of the prior Japanese Patent Application No. 2023-098484, filed on Jun. 15, 2023, the entire contents of which are incorporated herein by reference.

### BACKGROUND OF THE INVENTION

### Field of the Invention

The present disclosure relates to an information processing device, an information processing method, and a program.

### Description of the Related Art

As network technology develops, it has become possible to use data managed by an information processing device (e.g., a server, etc.) installed at a remote location by accessing the information processing device via a network, such as the Internet. Recently in particular, attention has been paid to the utilization of large-scale data; for example, a technique that enables the use of data managed by various institutions that are interspersed at remote locations for various analyses by remotely accessing servers and the like of the institutions has been studied. An example of such a technique is a technique referred to as Personal Health Train (PHT).

In the PHT, a virtual container referred to as a train sent from a requester visits information processing devices under management by institutions referred to as stations, executes a workflow that has been set in advance at each station, and returns to the requester, retaining results of the workflows. Such a scheme enables, for example, a user as a data consumer (e.g., an analyst, etc.) to obtain a result of executing desired processing targeting data managed by the institutions, via a network.
Patent Document 1 discloses an example of a technique referred to as streaming computing, as an example of a technique pertaining to the utilization of large-scale data via a network.
Patent Document 1: Japanese Laid-open Patent Publication No. 2022-013649

Meanwhile, under circumstances in which processing such as analysis is executed targeting data managed by a plurality of institutions (data providers) different from one another as in cases where the PHT mentioned above is applied, it is often the case that a method of managing data varies among the institutions. Under circumstances in which the method of managing data varies among institutions as data providers as in this case, it may be difficult to obtain an intended result in utilization of the data.

### SUMMARY OF THE INVENTION

In view of the problem described above, an object of the present invention is to achieve, even under circumstances in which a method of managing data varies among a plurality of providers, remote utilization of the data in a preferable mode.

An information processing device according to the present invention includes: a receiver configured to receive, via a network, a request pertaining to executing a series of processes defined in such a manner that one or more first processing units are arranged to be sequentially executed; an updater configured to update the series of processes by adding a second processing unit based on contents of the received request to a timing in the series of processes, the timing being based on the contents of the request; and a processor configured to execute the series of processes updated by the updater.

### BRIEF DESCRIPTION OF THE DRAWINGS

FIG. 1 is a diagram illustrating an example of a system configuration of an information processing system.

FIG. 2 is a diagram illustrating an example of a hardware configuration of an information processing device.

FIG. 3 is a diagram for describing an outline of PHT.

FIG. 4 is a diagram illustrating an example of a schematic configuration of the information processing system.

FIG. 5 is a diagram illustrating an outline of an example of processing pertaining to updating a workflow.

FIG. 6A to FIG. 6C are diagrams illustrating an outline of an example of results of updating a workflow.

FIG. 7 is a sequence diagram illustrating an example of processing by the information processing system.

FIG. 8 is a diagram illustrating an example of a setting pertaining to executing workflows.

FIG. 9A is a flowchart illustrating an example of processing by the information processing system.

FIG. 9B is the flowchart illustrating the example of the processing by the information processing system.

FIG. 9C is the flowchart illustrating the example of the processing by the information processing system.

FIG. 9D is the flowchart illustrating the example of the processing by the information processing system.

FIG. 10 is a sequence diagram illustrating an example of processing by the information processing system.

FIG. 11A and FIG. 11B are diagrams for describing an example of processing when a plurality of institutions are coordinated.

FIG. 12A and FIG. 12B are diagrams for describing an example of processing when a plurality of institutions are coordinated.

### DETAILED DESCRIPTION OF THE PREFERRED EMBODIMENTS

A preferred embodiment of the present disclosure will be described below in detail with reference to the accompanying drawings. Note that, in the present specification and the drawings, the same reference numerals are attached to constituent components having substantially the same functional configurations, and overlapping descriptions are not repeated.

Note that, in the present disclosure, a workflow is assumed to represent a series of processes defined in such a manner that one or more processes are arranged to be sequentially executed in a predetermined order. In the present disclosure, individual processes constituting a workflow may be each referred to as a processing unit so as to explicitly distinguish the process from a series of processes equivalent to the workflow.

### <System Configuration>

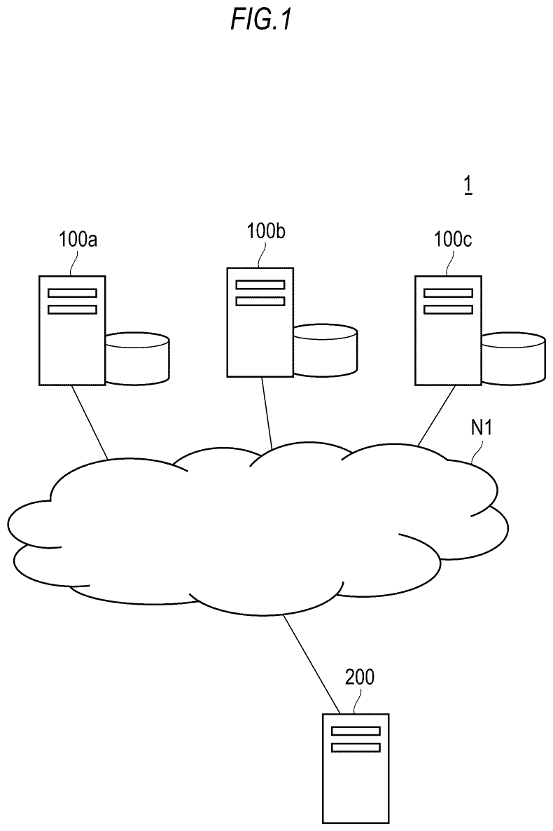

With reference to FIG. 1, an example of a system configuration of an information processing system according to an embodiment of the present disclosure will be described. An information processing system 1 according to the present embodiment is a system for achieving the execution of various types of remote processing such as analysis targeting data managed by a plurality of institutions (e.g., medical institutions). The information processing system 1 includes one or more information processing devices 100 under management by institutions as data providers (requestees of processing such as analysis) and a terminal device 200 under management by a data consumer (a requester of the processing such as analysis). In the example illustrated in FIG. 1, information processing devices 100a to 100c are illustrated as the one or more information processing devices 100. The one or more information processing devices 100 (e.g., the information processing devices 100a to 100c) and the terminal device 200 are connected together via a network N1 so as to transmit and receive information to and from one another.

The type of the network N1 that connects the devices constituting the information processing system 1 is not particularly limited. As a specific example, the network N1 may be configured of a local area network (LAN), the Internet, a dedicated line, a wide area network (WAN), or the like. The network N1 may be configured of a wired network or may be configured of a wireless network. The network N1 may include a plurality of networks, and as one or some of the networks, a network of a type different from the type of the other networks may be included. It is only required that communication among the devices is logically established, and the physical configuration of the network N1 is not particularly limited. As a specific example, the communication among the devices may be relayed by another communication device or the like. In addition, a series of the devices constituting the information processing system 1 need not necessarily be connected to a common network. That is, a network to which one or some of the devices are directly connected and a network to which the other devices are directly connected may be different from each other as long as it is possible to establish communication among the devices to and from which information and data are transmitted and received.

As mentioned above, the information processing devices 100 schematically represent information processing devices under the management by the institutions as data providers and are each implemented by, for example, an information processing device having a communication function, such as a server. Each of the information processing devices 100 receives a request pertaining to executing a workflow from the terminal device 200 described later and controls the execution of the workflow targeting data managed by itself, in accordance with the contents of the request. The information processing devices 100 according to the present embodiment also update a workflow as a target by adding, to the workflow, various processing units that perform protection of information included in data as a target, control of formatting of the data, and the like, in accordance with the contents of the received request. The processing by the information processing devices 100 will be separately described later in detail.

The terminal device 200 schematically represents an information processing device under management by a user as a requester of processing such as analysis, in other words, a user as a consumer of data managed by the information processing devices 100 and is implemented by, for example, an information processing device having a communication function, such as a personal computer (PC) or a server. The terminal device 200 receives, from the user as a requester of processing such as analysis, designation of a condition of processing as an execution target, a condition of data or information as a target of the processing, and the like to generate workflows and transmits requests pertaining to executing the workflows to the information processing devices 100. Note that a description will be given for the present embodiment with attention paid to a case where a technique referred to as Personal Health Train (PHT) is applied, so as to make features of the information processing system 1 easier to understand. The outline of the PHT will be separately described later.

### <Hardware Configuration>

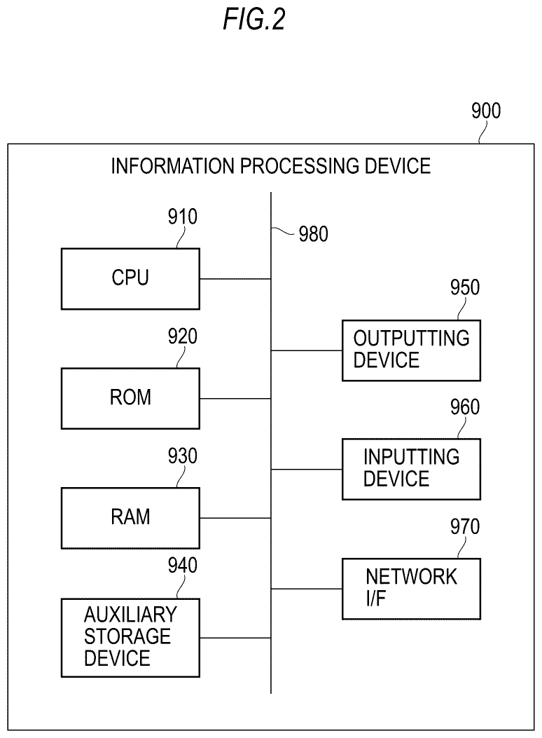

With reference to FIG. 2, an example of a hardware configuration of an information processing device 900 applicable as each of the devices constituting the information processing system according to an embodiment of the present disclosure (e.g., the information processing devices 100 and the terminal device 200 illustrated in FIG. 1, etc.) will be described. As illustrated in FIG. 2, the information processing device 900 according to the present embodiment includes a central processing unit (CPU) 910, a read only memory (ROM) 920, and a random access memory (RAM) 930. The information processing device 900 also includes an auxiliary storage device 940 and a network I/F 970. The information processing device 900 may also include at least any one of an outputting device 950 and an inputting device 960. The CPU 910, the ROM 920, the RAM 930, the auxiliary storage device 940, the outputting device 950, the inputting device 960, and the network I/F 970 are mutually connected via a bus 980.

The CPU 910 is a central processing unit that controls various operations of the information processing device 900. For example, the CPU 910 may control the operation of the entire information processing device 900. The ROM 920 stores a control program, a boot program, and the like that are executable by the CPU 910. The RAM 930 is a main memory for the CPU 910 and is used as a work area or a temporal storage area for loading various programs.

The auxiliary storage device 940 stores various types of data and various programs. The auxiliary storage device 940 is implemented by a storage device capable of temporarily or persistently storing the various types of data, such as a hard disk drive (HDD) or a nonvolatile memory, which is typified by a solid state drive (SSD).

The outputting device 950 is a device that outputs various types of information, and is used to present various types of information to a user. For example, the outputting device 950 can be implemented by a displaying device, such as a display. In this case, the outputting device 950 presents information to a user by displaying various types of indication information. Alternatively, as another example, the outputting device 950 may be implemented by a sound outputting device that outputs a voice or a sound such as an electronic sound. In this case, the outputting device 950 presents information to a user by outputting a voice or a sound such as an electronic sound. A device applied as the outputting device 950 may be changed as appropriate in accordance with a medium used to present information to a user.

The inputting device 960 is used to receive various instructions from a user. In the present embodiment, the inputting device 960 includes an inputting device such as a mouse, a keyboard, or a touch panel. Alternatively, as another example, the inputting device 960 may include a sound collecting device such as a microphone and collect a voice uttered by a user. In this case, the collected voice is subjected to various types of analytical processing such as acoustic analysis and natural language processing, and the contents represented by this voice are thereby recognized as instructions from a user. A device applied as the inputting device 960 may be changed as appropriate in accordance with a method of recognizing instructions from a user. Alternatively, a plurality of types of devices may be applied as the inputting device 960.

The network I/F 970 is used for communication with an external device via the network. Note that a device applied as the network I/F 970 may be changed as appropriate in accordance with a type of a communication route and a communications system to be applied.

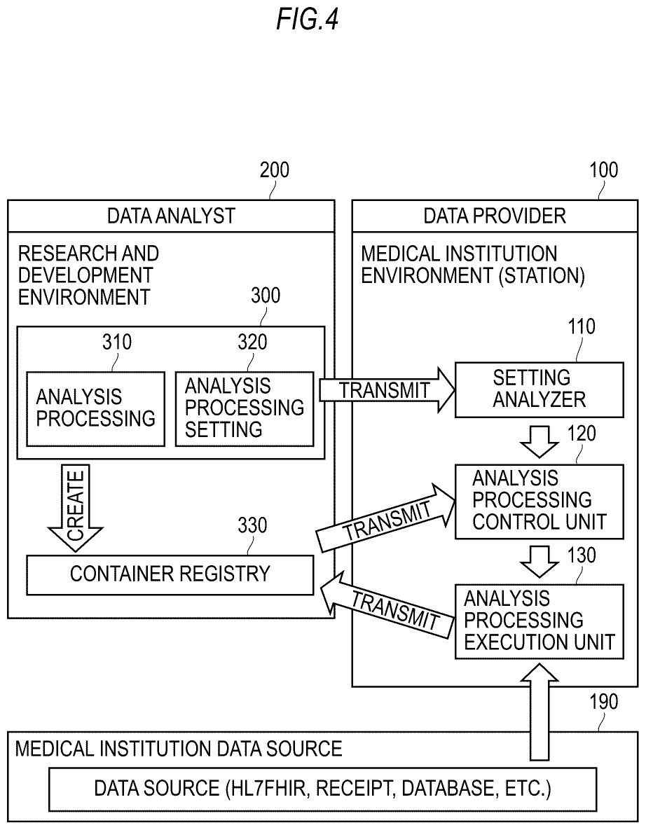

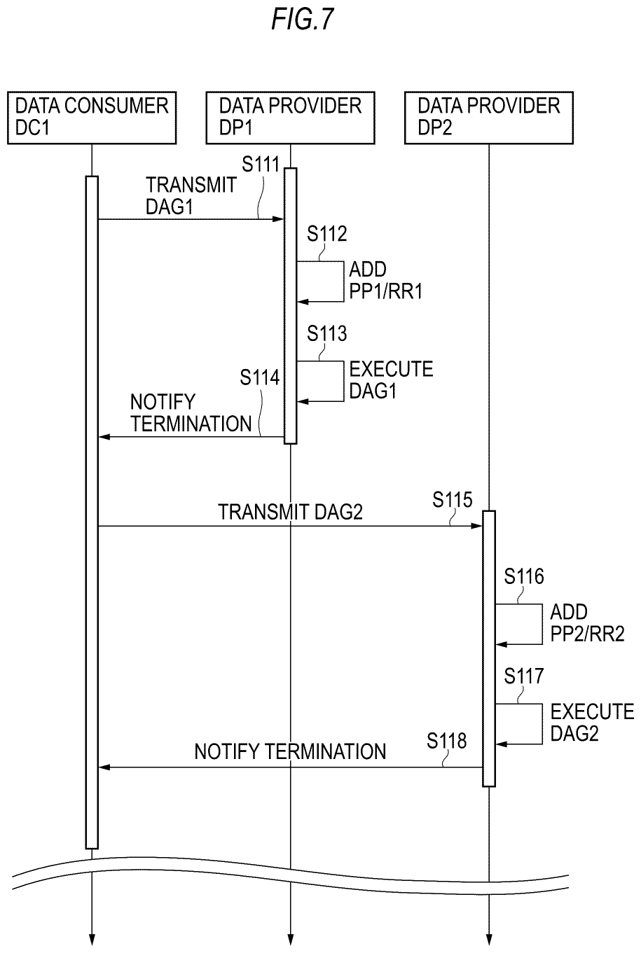

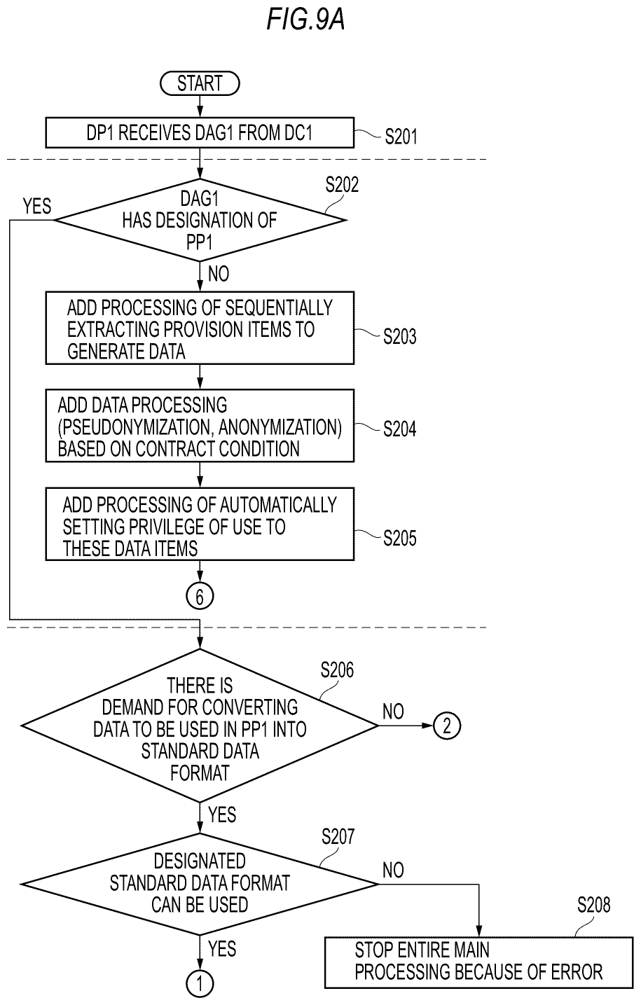

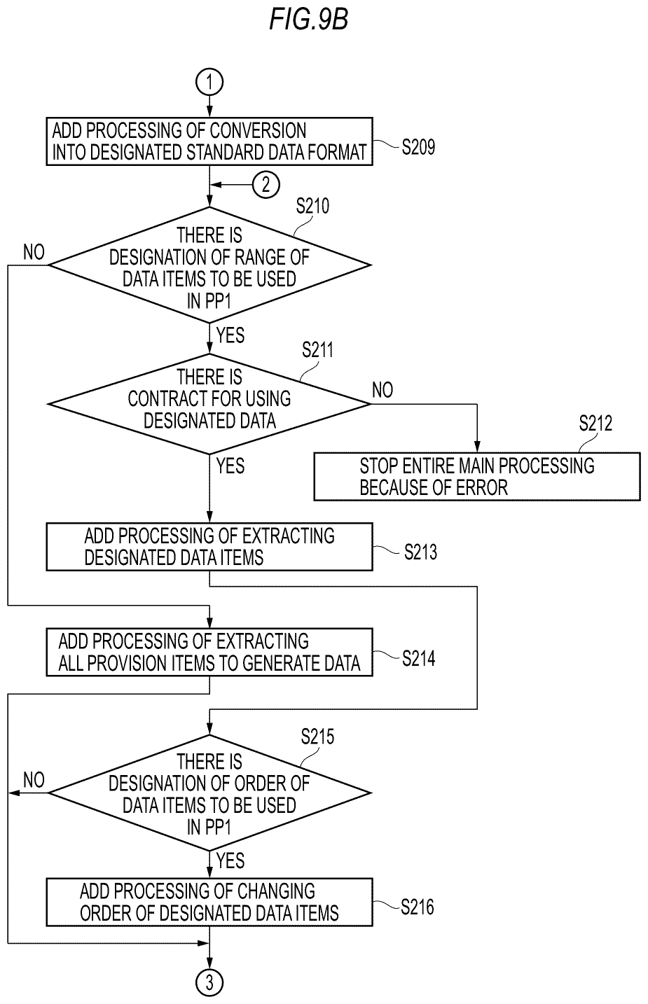

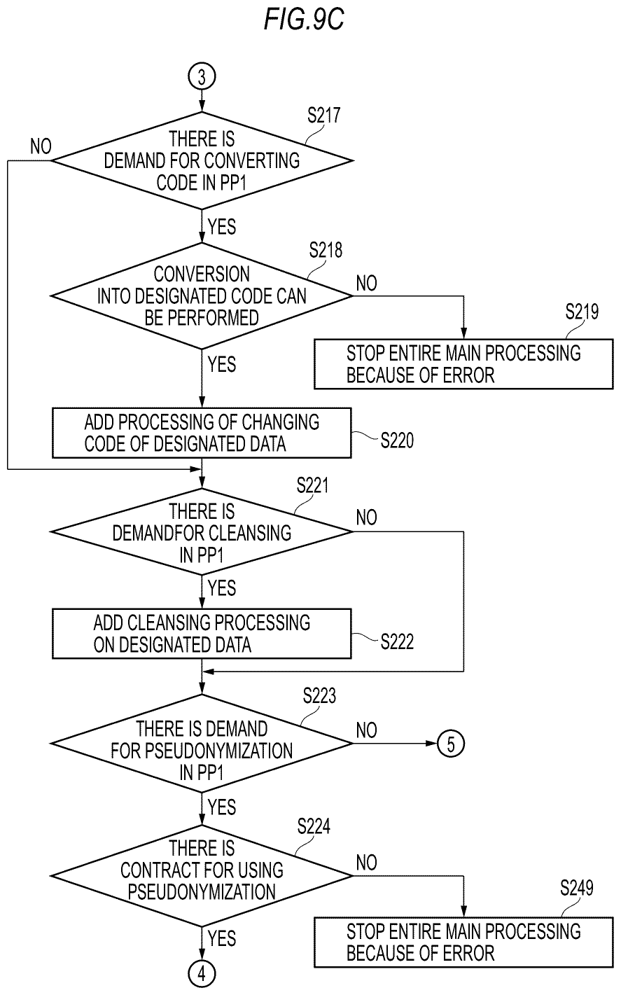

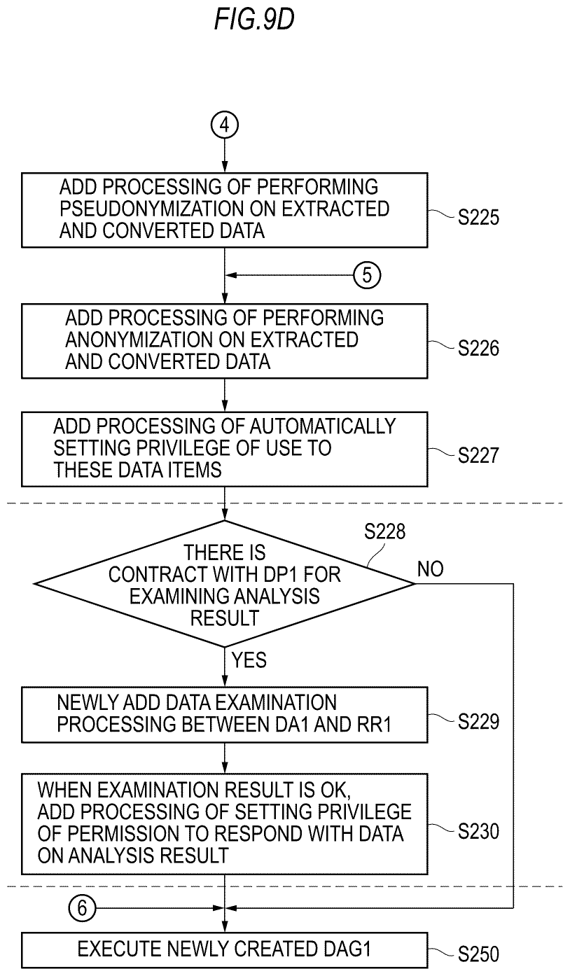

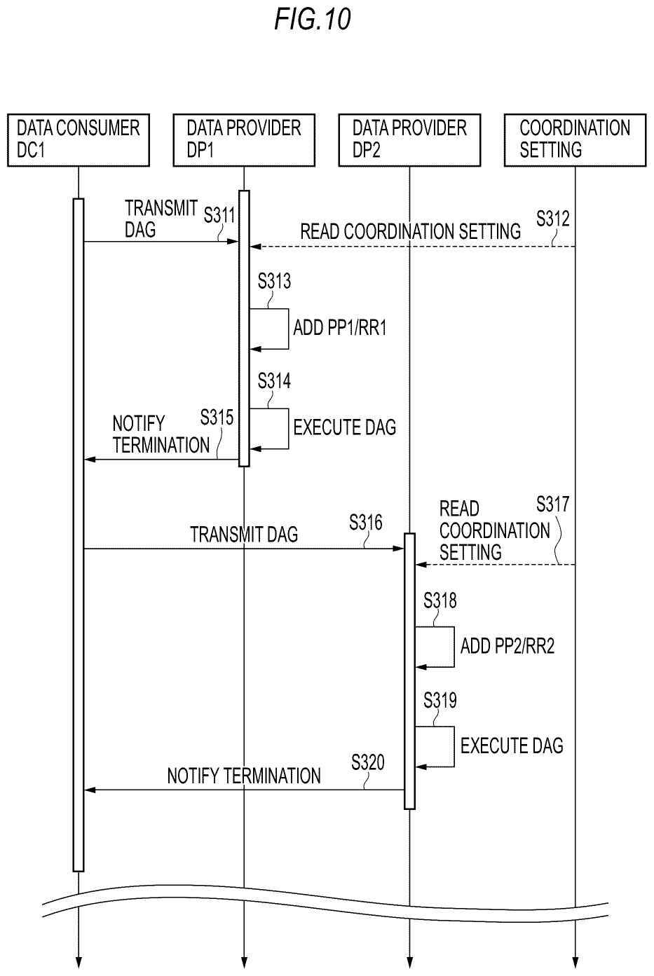

The CPU 910 loading programs stored in the ROM 920 or the auxiliary storage device 940 into the RAM 930 and executing these programs implement, for example, a functional configuration of the information processing device described later with reference to FIG. 4 and processing by the information processing device described later with reference to FIG. 7, FIG. 9A to FIG. 9D, and FIG. 10.

### <Outline of PHT and Its Technical Problems>

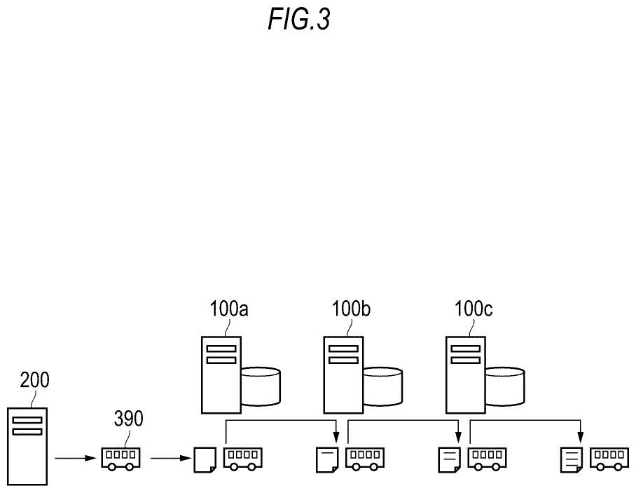

With reference to FIG. 3, an outline of a technique referred to as PHT will be described. The PHT is a technique that has been studied with a view to utilizing various types of data (e.g., clinical data, etc.) that are managed by a plurality of medical institutions, and an object of the PHT is particularly to achieve the execution of various types of remote processing such as analysis targeting these types of data.

Specifically, in the PHT, information processing devices 100 (also referred to as stations) of data providers such as medical institutions each manage actual data as a target of processing such as analysis, computational resources for executing the processing, and the like. In addition, a user equivalent to a user of data, such as a staff member of a research institution, sets an algorithm, a query, or the like of processing as an execution target for a virtual container referred to as a train, via a terminal device 200. Thus, a workflow as an execution target is set for a train 390. Subsequently, the terminal device 200 sends the train 390 to the stations (the information processing devices 100).

The train 390 sequentially visits a series of the stations (e.g., the information processing devices 100a to 100c), executes the workflow that has been set in the above manner (in other words, the algorithm or the query) at each station, and retains a result of processing of the workflow (e.g., a result of analysis and a learning model) at the station. In the above manner, the train 390 visits the series of stations, executes the workflow at each station, collects a result of executing the workflow, and then returns to the terminal device 200 as a sender.

The above scheme enables a user equivalent to a user of data to obtain a result of executing desired processing targeting data managed by institutions, via a network.

Note that the PHT exemplified above can be implemented by using, for example, a platform for a container-type virtual environment, such as Docker (registered trademark).

On the other hand, under circumstances in which processing using data managed by a plurality of institutions (data providers) is executed as in a case where the PHT is applied, it is often the case that a method of managing data (e.g., an approach to protecting the data, the format of the data, etc.) varies among the institutions. The variation in the method of managing data among institutions as data providers as in this case may cause such a harmful effect that an intended result cannot be obtained in utilization of the data.

As a specific example, circumstances in which data as a target of utilization includes information that is set as a concealment target, such as personal information, can be assumed. Under circumstances in which such data is used, the data as a target may be subjected to processing for protecting information as a concealment target (concealment processing) such as anonymization or pseudonymization. At the same time, circumstances in which measures pertaining to treating such information differ among institutions can also be assumed. Under such circumstances, for example, in a case where one or some of the institutions employ insufficient measures for treating information, a situation in which information as a concealment target included in data as a target is leaked from a consumer or the like may occur.

As another example, even for data for managing the same type of information, circumstances in which different institutes employ different formats of the data or employ different codes for denoting the same object can also be assumed. Under such circumstances, for example, a situation in which information demanded for processing such as analysis cannot be obtained in one or some of the institutions, or information items that intrinsically indicate the same object are recognized as different information items may occur, and as a result, it may be difficult to obtain a result with expected accuracy.

In view of such circumstances, the present disclosure proposes a scheme that can achieve, even under circumstances in which a method of managing data varies among providers of the data, remote utilization of data provided by a plurality of providers in a preferable mode.

### Outline of Functions

An outline of functions of the information processing system 1 according to an embodiment of the present disclosure will be described below together with an example of a schematic configuration of the information processing system 1. Note that various descriptions will be given for the present embodiment with attention paid to a case where processing such as analysis targeting data managed by information processing devices 100 under management by a plurality of institutions as data providers is executed, on the basis of a remote request from a terminal device 200 under management by a user as a data consumer, for the sake of convenience. In addition, it is assumed in the present embodiment that the PHT mentioned above is applied to achieve remote processing such as data analysis, for the sake of convenience.

For example, FIG. 4 is a diagram illustrating the example of the schematic configuration of the information processing system 1 according to the present embodiment. Note that, in the example illustrated in FIG. 4, it is assumed that a data analyst (a user of data) in a research and development environment uses a terminal device 200 to execute processing such as analysis, using data managed by information processing devices 100 under management by medical institutions as data providers.

The terminal device 200 includes a control unit 300 that performs various types of control pertaining to defining processing (e.g., analysis processing) to be executed by the information processing devices 100. The control unit 300 can be implemented by, for example, the platform for a container-type virtual environment mentioned above, such as Docker. A data source 190 schematically represents a constituent component for managing data in a medical institution and can be implemented by, for example, a database.

The control unit 300 receives, from the data analyst, instructions pertaining to executing a series of processes (a workflow) pertaining to analysis and the like and generates a container 310 that stores data (e.g., an application, a library, etc.) pertaining to defining an execution environment for each information processing device 100 to execute the series of processes. Note that this container 310 is equivalent to a train in the PHT.

The control unit 300 generates a container registry 330 for retaining the generated container 310 and stores the container 310 in the container registry 330. Using this container registry 330 enables an external device (e.g., the information processing device 100) to access the container 310 via the container registry 330, and thus, for example, it is also possible to share the container 310 in the system.

The control unit 300 generates, in association with the generated container 310, setting information that defines the contents of the series of processes such as analysis based on the instructions from the data analyst, that is, the series of processes executed by each information processing device 100 (hereinafter also referred to as an analysis processing setting 320). This analysis processing setting 320 includes, for example, information about a series of processing units executed as a workflow, the order of execution of the series of processing units, the container 310 pertaining to executing the workflow, and the like. For example, in a case where Docker is applied as a platform for a container-type virtual environment, a directed acyclic graph (DAG) is equivalent to an example of the analysis processing setting 320.

The control unit 300 sequentially transmits the generated analysis processing setting 320 to each of a series of the information processing devices 100 that retains data as a target of the processing such as analysis. In the above manner, a request pertaining to executing the series of processes (the workflow) targeting data managed by the series of information processing devices 100 is submitted to each of the information processing devices 100.

The information processing device 100 includes a setting analyzer 110, an analysis processing control unit 120, and an analysis processing execution unit 130.

The setting analyzer 110 receives a request that is transmitted from the terminal device 200 via the network and that pertains to executing the series of processes (the workflow) targeting the data managed by the information processing device 100 and analyzes the contents of the request to recognize various settings relating to the series of processes as an execution target. Specifically, the setting analyzer 110 receives the analysis processing setting 320 transmitted from the terminal device 200 and analyzes the contents of the analysis processing setting 320. The setting analyzer 110 thus recognizes information about the contents of the workflow as an execution target (e.g., the contents of the series of processing units, the order of execution of the series of processing units, etc.) and an execution environment of the workflow (the container 310).

On the basis of a result of analyzing the contents of the request (the analysis processing setting 320) by the setting analyzer 110, the analysis processing control unit 120 updates the series of processes (the workflow) designated as an execution target, by adding a processing unit based on the contents of the request to a timing based on the contents of the request in the series of processes.

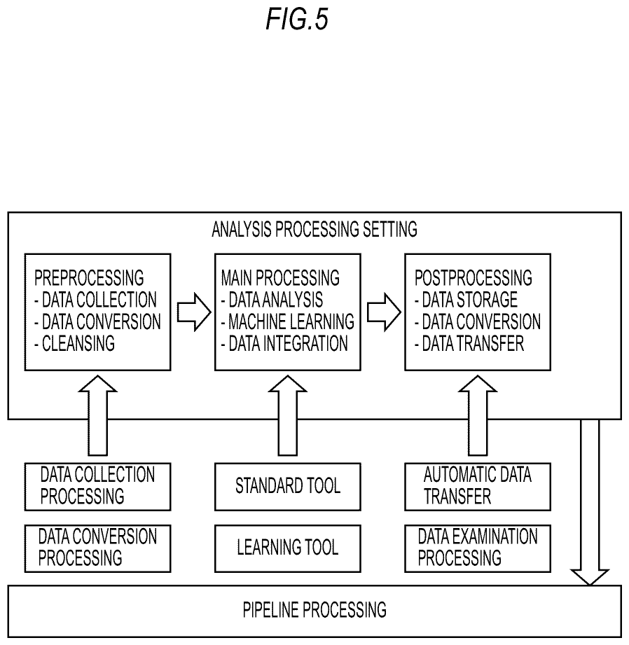

For example, FIG. 5 is a diagram illustrating an outline of an example of processing pertaining to updating, by the analysis processing control unit 120, a workflow as an execution target. A workflow as an execution target defined by the analysis processing setting 320 is defined such that, for example, processing units such as preprocessing, main processing, and postprocessing are executed in a predetermined order. The main processing is equivalent to substantial processing (a processing unit) targeting data managed by the information processing device 100 and can correspond to, for example, processing such as data analysis, machine learning, and data integration. The preprocessing is equivalent to processing (a processing unit) executed before the execution of the main processing and can correspond to, for example, processing such as data collection, data conversion, and cleansing. The postprocessing is equivalent to processing (a processing unit) additionally executed after the execution of the main processing and can correspond to, for example, processing such as data storage, data conversion, and data transfer.

The analysis processing control unit 120 updates the workflow defined as exemplified in FIG. 5 by adding a new processing unit as the preprocessing or postprocessing of the main processing to the workflow, in accordance with the contents of a request pertaining to executing the workflow. For example, in a case where data managed by the information processing device 100 includes information as a concealment target, such as personal information, the analysis processing control unit 120 may add, as the preprocessing of the main processing (e.g., analysis processing, etc.) targeting the data, a processing unit pertaining to concealing the information, such as anonymization or pseudonymization, to the information. Alternatively, as another example, the analysis processing control unit 120 may add, as the postprocessing of the main processing (e.g., analysis processing, etc.), a processing unit that subjects a result of the main processing to various types of examination and verification.

Note that processing units that are defined beforehand in a series of processes (a workflow) designated as an execution target are each equivalent to an example of a first processing unit, and a processing unit as an addition target is equivalent to an example of a second processing unit.

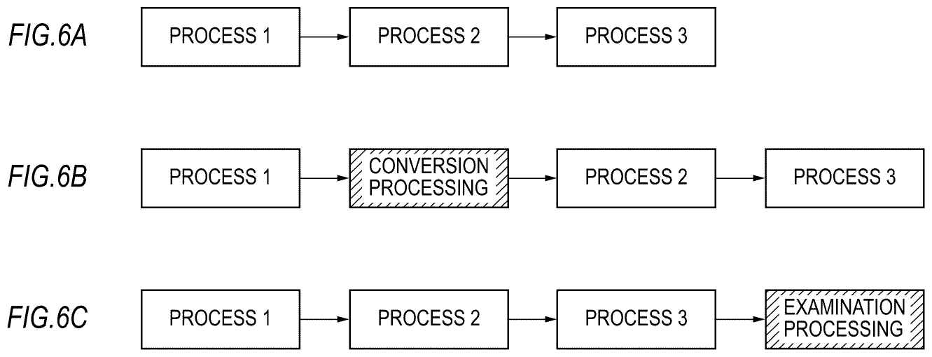

FIG. 6A to FIG. 6C are diagrams illustrating an outline of an example of results of updating a workflow by the analysis processing control unit 120. FIG. 6A illustrates an example of the workflow before being updated by the analysis processing control unit 120. In the example illustrated in FIG. 6A, the workflow is configured such that processing units denoted as a process 1, a process 2, and a process 3 are sequentially executed in this order. In contrast, FIG. 6B and FIG. 6C each illustrate an example of results of updating the workflow exemplified in FIG. 6A as a target, by adding a processing unit by the analysis processing control unit 120.

Specifically, in the example illustrated in FIG. 6B, a processing unit that performs conversion processing such as format conversion on data as a target of the process 2 is added to a timing (a processing turn) before a timing of executing the process 2. By applying such control, for example, even under circumstances in which different institutions employ different formats of data as a management target, it is possible to apply common processing (e.g., analysis processing) after the formats are made uniform.

In the example illustrated in FIG. 6C, a processing unit that performs various types of examination processing on a result of the process 1, the process 2, and the process 3 is added to a timing (a processing turn) after these processes are executed. By applying such control, for example, it is also possible to apply processing of checking whether the transfer of a result of processing targeting data managed by each institution to an external institution as a requester of the processing will cause any problem and then stopping the transfer as necessary.

Note that whether the analysis processing control unit 120 adds the preprocessing or postprocessing to the workflow may be determined in accordance with, for example, instructions from the terminal device 200 on the basis of instructions from a data analyst (e.g., information designated in the analysis processing setting 320). In this case, a flag that indicates the addition of the preprocessing or postprocessing to the workflow may be set in the analysis processing setting 320, or information that explicitly indicates the contents of a processing unit added to the workflow may be set in the analysis processing setting 320.

Alternatively, as another example, the information processing device 100 (the analysis processing control unit 120) may determine whether to add preprocessing or postprocessing to a workflow as an execution target in accordance with the contents of the analysis processing setting 320 (e.g., the contents, setting, etc. of the workflow).

Note that an example of a method of updating a workflow will be separately described later in detail.

The analysis processing execution unit 130 executes the workflow updated by the analysis processing control unit 120. As a specific example, the analysis processing execution unit 130 extracts data as a processing target of the workflow from the data source 190 and inputs the data to execute the workflow. At this time, the analysis processing execution unit 130 may access the container registry 330 generated in the terminal device 200 to execute the workflow using the container 310 (in other words, the analysis processing) retained in the container registry 330.

The workflow as a target may be executed in a form of, for example, what is called pipeline processing. Specifically, the data extracted from the data source 190 is input into a processing unit that is located at the head of the workflow, and a result of executing the processing unit is input into a processing unit that is next located. In the above manner, a series of processing units constituting the workflow is sequentially executed.

Then, when the execution of the workflow is completed, the analysis processing execution unit 130 transmits a result of the execution of the workflow to the terminal device 200 of the requester pertaining to the execution of the workflow. As a specific example, when determining that the return of data based on the result of the execution of the workflow (e.g., a result of the analysis processing, etc.) to the terminal device 200 will cause no problem, the analysis processing execution unit 130 may record the data in the container registry 330 generated in the terminal device 200.

Next, an example of a method of updating a workflow by the analysis processing control unit 120 will be described below with a specific example.

For example, the analysis processing control unit 120 may add a processing unit pertaining to controlling the privilege of access to data referred to when the workflow is executed, in accordance with which of a requester and a requestee pertaining to executing the workflow is an entity to which the data belongs. Note that the requester pertaining to executing the workflow here is equivalent to the terminal device 200 (a data analyst as an entity that manages the terminal device 200), that is, a consumer of data managed by the information processing device 100. In addition, the requestee pertaining to executing the workflow is equivalent to the information processing device 100 (a data provider as an entity that manages the information processing device 100), that is, a provider of the data managed by the information processing device 100.

As a specific example, when data as a target belongs to the requestee, the analysis processing control unit 120 may add a processing unit pertaining to controlling the privilege of access to the data, to a timing before a processing unit targeting the data (e.g., the main processing). As a more specific example, when no privilege of access for executing processing on data as a target is set, the analysis processing control unit 120 may enable the execution of the processing on the data by adding a processing unit that changes the privilege of access.

As another example, when data as a target (e.g., a result of the main processing) belongs to the requester, the analysis processing control unit 120 may add a processing unit pertaining to controlling the privilege of access to the data to a timing after a processing unit targeting the data (e.g., the main processing). As a more specific example, the analysis processing control unit 120 may determine whether a result of processing on data managed by the information processing device 100 is risk-free (e.g., whether the transfer of the result to the outside will cause any problem), and when determining that the result is risk-free, the analysis processing control unit 120 may set the privilege of access to the result of the processing such that the result can be transferred to the outside (e.g., the requester).

The analysis processing control unit 120 may add, in accordance with a type of at least part of information included in data as a target of the workflow, a processing unit that performs processing on the information, to a timing before a timing of the executing a processing unit targeting the data (e.g., the main processing). As a specific example, in a case where data as a target of the workflow includes information as a concealment target, such as personal information, the analysis processing control unit 120 may add, as preprocessing of a processing unit targeting the data, a processing unit that performs processing pertaining to concealing the information, such as anonymization or pseudonymization. By applying such control, for example, when a result of analyzing the data is provided to the data analyst, it is possible to prevent the occurrence of a situation in which personal information and the like included in the data is leaked.

Circumstances in which the format of data differs among institutions as providers of the data can be assumed. Therefore, for example, in a case where the format of data as a target of the workflow is different from a predetermined format, the analysis processing control unit 120 may add a processing unit that converts the format of the data into the predetermined format, to a timing before a timing of executing a processing unit targeting the data. As a specific example, the analysis processing control unit 120 may add, as preprocessing of the processing unit targeting the data as a target of the workflow, a processing unit that converts the format of the data into a standard format conforming to a predetermined protocol. By applying such control, for example, under circumstances in which a workflow (e.g., analysis processing, etc.) targeting data managed by a plurality of institutions is executed, it is possible to execute, for example, processing in which data items that are managed by institutions different from one another are comparison targets.

In a case where at least part of information included in data as a target is denoted by a code or the like for specifying an object rather than a name denoting the object, circumstances in which different types of codes are applied by different institutions as providers of the data can be assumed. As a specific example, a case where a standardized code, such as a HOT reference code (HOT reference code: Standard Master for Pharmaceutical Products in Japan. e.g., HOT7, HOT9, HOT11, HOT13, etc.), is used as information denoting ethical drugs in medical institutions or a case where a code that is peculiarly assigned by a medical institution is used can be assumed. In addition, the standardized code is not limited to the HOT reference code, and circumstances in which another code for identifying medicines, a code for identifying medicines as commercial products, such as the Japanese Article Number, or the like is used can also be assumed.

Therefore, for example, in a case where the type of a code for specifying an object that is used for at least part of information included in data as a target of a workflow is different from the type of a predetermined code, the analysis processing control unit 120 may add a processing unit that converts the code as a target into the predetermined code, to a timing before a timing of executing a processing unit targeting the data. By applying such control, for example, under circumstances in which a workflow (e.g., analysis processing, etc.) targeting data managed by a plurality of institutions is executed, it is possible to execute, for example, processing in which data items that are managed by institutions different from one another are comparison targets.

In addition, a case where a series of data items as a target includes corrupted data, incorrect data, or the like is also assumed, and in such a case, circumstances in which the accuracy of a result of processing (e.g., analysis processing) targeting the series of data items decreases can also be assumed. Under such circumstances, for example, what is called cleansing processing of recovering corrupted data and deleting incorrect data such as data including a missing value may be performed on the data items as targets, and then desired processing may be performed.

Therefore, for example, in accordance with a state of data as a target of a workflow, the analysis processing control unit 120 may add a processing unit that performs the cleansing processing on the data, to a timing before a timing of executing a processing unit targeting the data. As a specific example, in a case where data as a target of a workflow includes corrupted data or incorrect data, or in a case where a proportion of the corrupted data or the incorrect data exceeds a threshold value, the analysis processing control unit 120 may add a processing unit that performs the cleansing processing as exemplified above.

In accordance with the type of at least part of information included in data as a target of a workflow, the analysis processing control unit 120 may add a processing unit pertaining to examination targeting a result of executing a processing unit targeting the data (e.g., the main processing), to a timing after a timing of executing the processing unit targeting the data. As a specific example, in a case where data as a target of a workflow includes information as a concealment target, such as personal information, the analysis processing control unit 120 may add a processing unit that examines whether a result of executing the workflow includes information as a concealment target. By applying such control, for example, even when pseudonymization or anonymization of information as a concealment target included in data as a target of a workflow is insufficient, it is possible to prevent the occurrence of a situation in which the information is leaked to the outside.

Note that the configuration mentioned above is merely an example, and any configuration is possible as long as the terminal device 200 can remotely cause the series of information processing devices 100 to execute processing (a workflow) targeting data under management by the information processing devices 100. For example, although the description of an example of the configuration has been given above with attention paid to a case where the PHT is applied, another technique pertaining to utilizing data managed by institutions may be applied. In addition, a platform for achieving these techniques may be changed as appropriate, and at least part of the configuration may be changed as appropriate in conformity to specifications of a platform to be applied (e.g., another platform in which a virtual container can be used).

### <Processing>

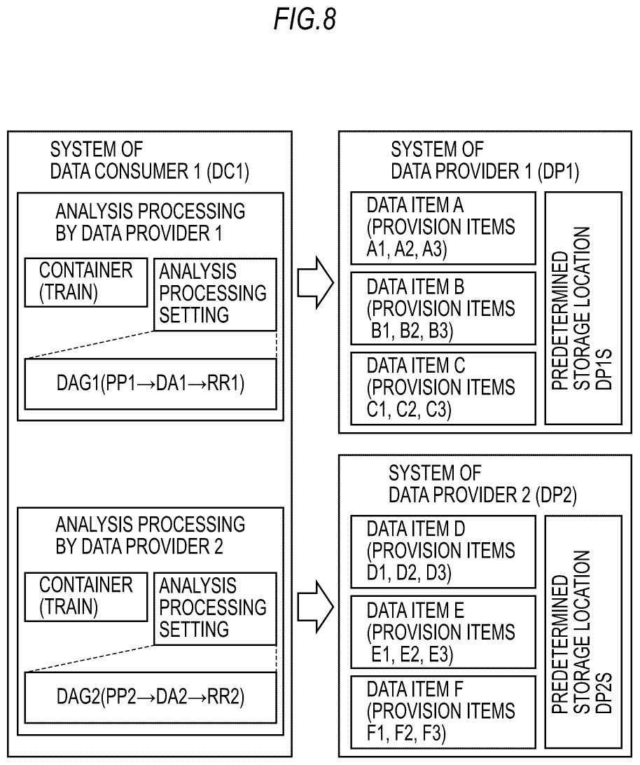

With reference to FIG. 7 and FIG. 8, an example of processing by the information processing system 1 according to the present embodiment will be described. FIG. 7 is a sequence diagram illustrating an example of the processing by the information processing system 1 according to the present embodiment. FIG. 8 is a diagram illustrating an example of a setting pertaining to executing workflows. Note that, in the examples illustrated in FIG. 7 and FIG. 8, an example of a case where a data consumer DC1 (DC: Data Consumer) as a requester makes a request for analysis processing targeting data managed by data providers DP1 and DP2 (DP: Data Provider) will be described, so as to make features of the processing by the information processing system 1 easier to understand. It is assumed that DAG1 denotes an analysis processing setting that is transmitted from a terminal device 200 of DC1 to an information processing device 100 of DP1. It is assumed that DAG2 denotes an analysis processing setting that is transmitted from the terminal device 200 of DC1 to an information processing device 100 of DP2.

Processes of S111 to S114 illustrated in FIG. 7 show an example of a processing sequence, from the data consumer DC1 to the data provider DP1, pertaining to executing the analysis processing targeting data managed by the data provider DP1.

As illustrated in FIG. 8, the analysis processing setting DAG1 corresponding to the data provider DP1 is defined to execute a workflow constituted by preprocessing PP1, main processing DA1, and postprocessing RR1. The information processing device 100 of the data provider DP1 manages data items A, B, and C. The data item A includes A1, A2, and A3 as items of information as provision targets (hereinafter also referred to as provision items). The data item B includes B1, B2, and B3 as provision items. The data item C includes C1, C2, and C3 as provision items. Additionally, information items corresponding to the provision items A2, B2, and C2 are assumed to be set as information items as concealment targets (e.g., personal information items).

Specifically, in S111, the terminal device 200 of the data consumer DC1 generates the analysis processing setting DAG1 of a workflow as an execution target of the information processing device 100 of the data provider DP1, in accordance with instructions from a user of the data consumer DC1. Subsequently, the terminal device 200 transmits the generated analysis processing setting DAG1 to the information processing device 100 of the data provider DP1.

In S112, on the basis of the analysis processing setting DAG1 received from the terminal device 200 of the data consumer DC1, the information processing device 100 of the data provider DP1 adds processing units corresponding to the preprocessing and the postprocessing to the workflow as an execution target. As a specific example, in order to protect the information items as concealment targets corresponding to the provision items A2, B2, and C2, the information processing device 100 may add a processing unit that performs pseudonymization or anonymization on these information items as the preprocessing of the main processing targeting the information items. In the above manner, the workflow as an execution target is updated.

In S113, the information processing device 100 of the data provider DP1 executes the workflow corresponding to the analysis processing setting DAG1 and updated in S112. As a specific example, the information processing device 100 may execute the workflow as a target on the basis of, for example, a container 310 corresponding to the analysis processing setting DAG1 that is retained in a container registry 330 managed by the terminal device 200.

Then, in S114, when the execution of the workflow as a target is completed, the information processing device 100 of the data provider DP1 notifies the terminal device 200 of the data consumer DC1 of the termination of the workflow. A result of executing the workflow is recorded in the container registry 330 managed by the terminal device 200.

Processes of S115 to S118 illustrated in FIG. 7 show an example of a processing sequence, from the data consumer DC1 to the data provider DP2, pertaining to executing the analysis processing targeting data managed by the data provider DP2.

As illustrated in FIG. 8, the analysis processing setting DAG2 corresponding to the data provider DP2 is defined to execute a workflow constituted by preprocessing PP2, main processing DA2, and postprocessing RR2. The information processing device 100 of the data provider DP2 manages data items D, E, and F. The data item D includes D1, D2, and D3 as provision items. The data item E includes E1, E2, and E3 as provision items. The data item F includes F1, F2, and F3 as provision items. Additionally, information items corresponding to the provision items D2, E2, and F2 are assumed to be set as information items as concealment targets (e.g., personal information items).

Specifically, in S115, the terminal device 200 of the data consumer DC1 generates the analysis processing setting DAG2 of a workflow as an execution target of the information processing device 100 of the data provider DP2, in accordance with instructions from a user of the data consumer DC1. Subsequently, the terminal device 200 transmits the generated analysis processing setting DAG2 to the information processing device 100 of the data provider DP2.

In S116, on the basis of the analysis processing setting DAG2 received from the terminal device 200 of the data consumer DC1, the information processing device 100 of the data provider DP2 adds processing units corresponding to the preprocessing and the postprocessing to the workflow as an execution target. As a specific example, in order to protect the information items as concealment targets corresponding to the provision items D2, E2, and F2, the information processing device 100 may add a processing unit that performs pseudonymization or anonymization on these information items as the preprocessing of the main processing targeting the information items. In the above manner, the workflow as an execution target is updated.

In S117, the information processing device 100 of the data provider DP2 executes the workflow corresponding to the analysis processing setting DAG2 and updated in S116. As a specific example, the information processing device 100 may execute the workflow as a target on the basis of, for example, a container 310 corresponding to the analysis processing setting DAG2 that is retained in a container registry 330 managed by the terminal device 200.

Then, in S118, when the execution of the workflow as a target is completed, the information processing device 100 of the data provider DP2 notifies the terminal device 200 of the data consumer DC1 of the termination of the workflow. A result of executing the workflow is recorded in the container registry 330 managed by the terminal device 200.

By applying the above control, for example, it is possible to achieve control under which a train sent from the terminal device 200 of the data consumer DC1 sequentially visits the information processing devices 100 (stations) of the data providers DP1 and DP2 to execute workflows. In addition, as shown as the processes S112 and S116, in each of the information processing devices 100 of the data providers DP1 and DP2, the processing units equivalent to the preprocessing and the postprocessing of the main processing are added to the workflow as a target. By applying such control, for example, even under circumstances in which a method of managing data differs (the method of managing data varies) between the data providers DP1 and DP2, it is possible to achieve remote utilization of the data in a preferable mode.

### EXAMPLE

With reference to FIG. 9A to FIG. 9D, an example of the information processing system 1 according to the present embodiment will be described with a specific example. FIG. 9A to FIG. 9D are flowcharts illustrating an example of processing by an information processing device 100 of a data provider DP1 in the information processing system 1 according to the present embodiment. Note that, in the present example, it is assumed that a terminal device 200 of a data consumer DC1 gives instructions as to whether to add preprocessing or postprocessing to a workflow, and that the determination of a processing unit as an addition target based on the instructions is made by the information processing device 100 of the data provider DP1.

In S201, the information processing device 100 of the data provider DP1 receives an analysis processing setting DAG1 transmitted from a terminal device 200 of a data consumer DC1.

In S202, the information processing device 100 determines, for the analysis processing setting DAG1 received in S201, whether there is designation pertaining to adding preprocessing PP1 to main processing DA1.

When determining in S202, for the analysis processing setting DAG1, that there is no designation pertaining to adding the preprocessing PP1, the information processing device 100 causes the processing illustrated in the flowchart to proceed to S203.

On the other hand, when determining in S202, for the analysis processing setting DAG1, that there is the designation pertaining to adding the preprocessing PP1, the information processing device 100 causes the processing illustrated in the flowchart to proceed to S206.

In S203, on the basis of the analysis processing setting DAG1, the information processing device 100 adds, to the workflow, processing of sequentially extracting information items corresponding to provision items as processing targets of the workflow from a series of data items managed by the information processing device 100 itself to generate input data for the main processing in the workflow.

In S204, in a case where a condition based on a contract between the data provider and the data consumer is set beforehand, the information processing device 100 adds, on the basis of the condition, a processing unit that performs predetermined data processing (e.g., pseudonymization, anonymization, etc.) on the input data as preprocessing of the main processing targeting the input data in the workflow. Note that the presence or absence of the contract between the data provider and the data consumer can be determined based on, for example, setting information that is retained in a predetermined storage area or a result of executing predetermined authentication processing.

In S205, the information processing device 100 adds a processing unit pertaining to setting the privilege of use for executing processing defined in the workflow (e.g., analysis processing) on the input data generated in S203, as preprocessing of the main processing targeting the input data in the workflow. Subsequently, the information processing device 100 causes the processing illustrated in the flowchart to proceed to S250 in FIG. 9D.

In S206, the information processing device 100 determines, for the analysis processing setting DAG1, whether a demand for adding, as preprocessing, processing of converting a data format of data as a processing target of the workflow into a standard data format is included.

When determining in S206, for the analysis processing setting DAG1, that the demand for adding, as preprocessing, the processing of converting the data format of the data as a processing target of the workflow into the standard data format is included, the information processing device 100 causes the processing illustrated in the flowchart to proceed to S207.

On the other hand, when determining in S206, for the analysis processing setting DAG1, that the demand for adding, as preprocessing, the processing of converting the data format of the data as a processing target of the workflow into the standard data format is not included, the information processing device 100 causes the processing illustrated in the flowchart to proceed to S210 in FIG. 9B.

In S207, the information processing device 100 determines, for the analysis processing setting DAG1, whether the standard data format designated as a conversion destination can be used.

When determining in S207, for the analysis processing setting DAG1, that the standard data format designated as the conversion destination can be used, the information processing device 100 causes the processing illustrated in the flowchart to proceed to S209 in FIG. 9B.

On the other hand, when determining in S207, for the analysis processing setting DAG1, that the standard data format designated as the conversion destination cannot be used, the information processing device 100 causes the processing illustrated in the flowchart to proceed to S208. In this case, in S208, the information processing device 100 determines that an error has occurred, executes processing for the occurrence of the error, and then terminates the series of processes illustrated in FIG. 9A to FIG. 9D.

Next, FIG. 9B will be referred to.

In S209, the information processing device 100 adds a processing unit that converts the data format of the data as a processing target of the workflow into the standard data format, as preprocessing of the main processing targeting the data in the workflow.

In S210, the information processing device 100 determines, for the analysis processing setting DAG1, whether there is designation of a range of items used out of a series of provision items in the data as a target, as preprocessing.

When determining in S210, for the analysis processing setting DAG1, that there is the designation of the range of the items used out of the series of provision items in the data as a target, the information processing device 100 causes the processing illustrated in the flowchart to proceed to S211.

On the other hand, when determining in S210 that there is no designation of the range of the items used out of the series of provision items in the data as a target, the information processing device 100 causes the processing illustrated in the flowchart to proceed to S214.

In S211, the information processing device 100 determines whether any contract pertaining to using the data as a target is set between the data provider and the data consumer. Note that the presence or absence of the contract between the data provider and the data consumer can be determined based on, for example, setting information that is retained in a predetermined storage area or a result of executing predetermined authentication processing.

When determining in S211 that the contract pertaining to using the data as a target is set between the data provider and the data consumer, the information processing device 100 causes the processing illustrated in the flowchart to proceed to S213.

On the other hand, when determining in S211 that the contract pertaining to using the data as a target is not set between the data provider and the data consumer, the information processing device 100 causes the processing illustrated in the flowchart to proceed to S212. In this case, in S212, the information processing device 100 determines that an error has occurred, executes processing for the occurrence of the error, and then terminates the series of processes illustrated in FIG. 9A to FIG. 9D.

In S213, the information processing device 100 adds processing of sequentially extracting, from the series of data items managed by the information processing device 100 itself, information items corresponding to the range of provision items designated in the analysis processing setting DAG1 to generate input data for the main processing in the workflow, as preprocessing of the main processing targeting the input data in the workflow. Subsequently, the information processing device 100 causes the processing illustrated in the flowchart to proceed to S215.

In S214, the information processing device 100 adds processing of sequentially extracting, from the series of data items managed by the information processing device 100 itself, information items corresponding to a series of provision items as a processing target of the workflow to generate input data for the workflow, as preprocessing of the main processing targeting the input data in the workflow. Subsequently, the information processing device 100 causes the processing illustrated in the flowchart to proceed to S217 in FIG. 9C.

In S215, the information processing device 100 determines, for the analysis processing setting DAG1, whether there is designation of the order of a series of items in the input data used in the preprocessing (the input data generated in S213).

When determining in S215, for the analysis processing setting DAG1, that there is the designation of the order of the series of items in the input data used in the preprocessing, the information processing device 100 causes the processing illustrated in the flowchart to proceed to S216.

On the other hand, when determining in S215, for the analysis processing setting DAG1, that there is no designation of the order of the series of items in the input data used in the preprocessing, the information processing device 100 causes the processing illustrated in the flowchart to proceed to S217 in FIG. 9C.

In S216, the information processing device 100 adds a processing unit that converts the order of the series of items in the input data used in the preprocessing into the order designated in the analysis processing setting DAG1, as preprocessing of the main processing targeting the input data in the workflow. Subsequently, the information processing device 100 causes the processing illustrated in the flowchart to proceed to S217 in FIG. 9C.

Next, FIG. 9C will be referred to.

In S217, the information processing device 100 determines, for the analysis processing setting DAG1, whether there is a demand pertaining to, as preprocessing, converting a code for specifying an object that is set as information corresponding to at least one or some of the provision items in the data.

When determining in S217, for the analysis processing setting DAG1, that there is the demand pertaining to, as preprocessing, converting the code for specifying the object that is set as the information corresponding to at least one or some of the provision items in the data, the information processing device 100 causes the processing illustrated in the flowchart to proceed to S218.

On the other hand, when determining in S217, for the analysis processing setting DAG1, that there is no demand pertaining to, as preprocessing, converting the code for specifying the object that is set as the information corresponding to at least one or some of the provision items in the data, the information processing device 100 causes the processing illustrated in the flowchart to proceed to S221.

In S218, the information processing device 100 determines whether a code designated as a conversion destination in the analysis processing setting DAG1 can be used (i.e., whether conversion into the designated code can be performed).

When determining that the code designated as the conversion destination in the analysis processing setting DAG1 can be used, the information processing device 100 causes the processing illustrated in the flowchart to proceed to S220.

On the other hand, when determining that the code designated as the conversion destination in the analysis processing setting DAG1 cannot be used, the information processing device 100 causes the processing illustrated in the flowchart to proceed to S219. In this case, in S219, the information processing device 100 determines that an error has occurred, executes processing for the occurrence of the error, and then terminates the series of processes illustrated in FIG. 9A to FIG. 9D.

In S220, the information processing device 100 adds a processing unit that converts a code that is set as an information item corresponding to a provision item as a target into the code designated as the conversion destination in the analysis processing setting DAG1, as preprocessing of the main processing on the data as a target in the workflow. Thus, for example, even when a code peculiar to an institution as a target is used in the institution as a code for specifying an object, it is possible to convert the peculiar code into a code that is used as a standard. The information processing device 100 then causes the processing illustrated in the flowchart to proceed to S221.

In S221, the information processing device 100 determines, for the analysis processing setting DAG1, whether there is a demand pertaining to, as preprocessing, cleansing processing on the data as a target.

When determining in S221, for the analysis processing setting DAG1, that there is the demand pertaining to, as preprocessing, the cleansing processing on the data as a target, the information processing device 100 causes the processing illustrated in the flowchart to proceed to S222.

On the other hand, when determining in S221, for the analysis processing setting DAG1, that there is no demand pertaining to, as preprocessing, the cleansing processing on the data as a target, the information processing device 100 causes the processing illustrated in the flowchart to proceed to S223.

In S222, the information processing device 100 adds a processing unit that performs the cleansing processing on the data as a target, as preprocessing of the main processing targeting the data.

In S223, the information processing device 100 determines, for the analysis processing setting DAG1, whether there is a demand for, as preprocessing, pseudonymization of information included in data as a processing target of the workflow.

When determining in S223, for the analysis processing setting DAG1, that there is the demand for, as preprocessing, the pseudonymization of the information included in the data as a processing target of the workflow, the information processing device 100 causes the processing illustrated in the flowchart to proceed to S224.

On the other hand, when determining in S223, for the analysis processing setting DAG1, that there is no demand for, as preprocessing, the pseudonymization of the information included in the data as a processing target of the workflow, the information processing device 100 causes the processing illustrated in the flowchart to proceed to S226 in FIG. 9D.

In S224, the information processing device 100 determines whether any contract pertaining to using pseudonymization of the data as a target is set between the data provider and the data consumer. Note that the presence or absence of the contract between the data provider and the data consumer can be determined based on, for example, setting information that is retained in a predetermined storage area or a result of executing predetermined authentication processing.

When determining in S224 that the contract pertaining to using the pseudonymization of the data as a target is set between the data provider and the data consumer, the information processing device 100 causes the processing illustrated in the flowchart to proceed to S225 in FIG. 9D.

On the other hand, when determining in S224 that the contract pertaining to using the pseudonymization of the data as a target is not set between the data provider and the data consumer, the information processing device 100 causes the processing illustrated in the flowchart to proceed to S249. In this case, in S249, the information processing device 100 determines that an error has occurred, executes processing for the occurrence of the error, and then terminates the series of processes illustrated in FIG. 9A to FIG. 9D.

Next, FIG. 9D will be referred to.

In S225, the information processing device 100 adds a processing unit that performs the pseudonymization on the information included in the data as a processing target of the workflow, as preprocessing of the main processing targeting the data in the workflow.

In S226, the information processing device 100 adds a processing unit that performs anonymization on the information included in the data as a processing target of the workflow, as preprocessing of the main processing targeting the data in the workflow.

In S227, the information processing device 100 adds a processing unit that adds the privilege of use for executing the workflow to the data as a processing target of the workflow, as preprocessing of the main processing targeting the data in the workflow.

In S228, the information processing device 100 determines whether any contract pertaining to performing examination on a result of analysis of the data as a processing target of the workflow is set between the data provider and the data consumer. Note that the presence or absence of the contract between the data provider and the data consumer can be determined based on, for example, setting information that is retained in a predetermined storage area or a result of executing predetermined authentication processing.

When determining in S228 that the contract pertaining to performing the examination on the result of the analysis of the data as a processing target of the workflow is set between the data provider and the data consumer, the information processing device 100 causes the processing illustrated in the flowchart to proceed to S229.

On the other hand, when determining in S228 that the contract pertaining to performing the examination on the result of the analysis of the data as a processing target of the workflow is not set between the data provider and the data consumer, the information processing device 100 causes the processing illustrated in the flowchart to proceed to S250.

In S229, the information processing device 100 adds a processing unit that performs the examination on the result of the analysis of the data as a processing target of the workflow, as postprocessing of the main processing targeting the data. At this time, the information processing device 100 may add the above processing unit between the main processing and postprocessing that is set beforehand for the main processing.

In S230, when a result of the execution of the processing unit pertaining to the examination added to the workflow in S229 is satisfactory, the information processing device 100 adds a processing unit that sets, for the result of the analysis as a target, the privilege of permission to respond with the result of the analysis to the data consumer, as postprocessing of the processing unit pertaining to the examination in the workflow.

In S250, the information processing device 100 executes the workflow based on the analysis processing setting DAG1 that is newly created by the series of processes mentioned above, that is, the workflow to which various processing units are added, and transmits a result of the execution to the terminal device 200 of the data consumer.

In the above manner, the series of processes illustrated in FIG. 9A to FIG. 9D is sequentially executed by each of the information processing devices 100 (stations) of the data providers as visiting targets of the train.

The example of the information processing system 1 according to the present embodiment has been described above with a specific example, with reference to FIG. 9A to FIG. 9D.

### Modification

With reference to FIG. 10 to FIG. 12B, a modification of the information processing system according to an embodiment of the present disclosure will be described. In the embodiment and the example mentioned above, an example of the case where a plurality of institutions (stations) as data providers execute workflows independently and separately has been described. In contrast, a case where a plurality of institutions execute a workflow in coordination with one another can be assumed, such as a case where, based on a result of analysis processing executed by one or some of institutions, another institution executes separate processing (e.g., analysis processing, examination processing, etc.). Accordingly, in the present modification, an example of a case where a plurality of institutions (stations) are caused to execute one workflow in coordination with one another will be described.

First, with reference to FIG. 10, an example of a flow of processing by the information processing system 1 according to the present modification will be described. Note that, in the example illustrated in FIG. 10, it is assumed that data providers DP1 and DP2 execute one workflow in coordination with each other on the basis of a request from a data consumer DC1 as a requester.

A coordination setting illustrated in FIG. 10 is equivalent to setting information for coordinated operation of the data providers DP1 and DP2 and is shared between the data providers DP1 and DP2. As a specific example, the coordination setting may be implemented in a form of a file or a registry that can be referred to by both data providers DP1 and DP2. As another example, the sharing of the coordination setting may be implemented in a pseudo manner by the data providers DP1 and DP2 separately retaining the same coordination setting. For the coordination setting, for example, various types of information about targets and the order of the coordinated operation, the contents of the coordinated operation (e.g., data standardization, cooperation among a plurality of institutions, etc.), data as a target of the cooperation among the plurality of institutions, and the like can be set.

In S311, a terminal device 200 of the data consumer DC1 generates an analysis processing setting DAG1 of a workflow as an execution target, in accordance with instructions from a user of the data consumer DC1. It is assumed here that the terminal device 200 generates an analysis processing setting DAG1 of a workflow executed by an information processing device 100 of the data provider DP1 in collaboration with an information processing device 100 of the data provider DP2. Subsequently, the terminal device 200 transmits the generated analysis processing setting DAG1 to the information processing device 100 of the data provider DP1. The terminal device 200 also generates a coordination setting including setting information for the data providers DP1 and DP2 to execute the workflow in collaboration with each other and causes the data providers DP1 and DP2 to share the coordination setting. As a specific example, the terminal device 200 may retain the generated coordination setting in a registry that can be referred to by both data providers DP1 and DP2 and may notify the data providers DP1 and DP2 of information for accessing the registry.

In S312, when receiving the analysis processing setting DAG1 from the terminal device 200 of the data consumer DC1, the information processing device 100 of the data provider DP1 reads the coordination setting on the basis of the notification from the terminal device 200. On the basis of a result of reading the coordination setting, the information processing device 100 of the data provider DP1 specifies a setting and processing pertaining to the collaboration with an information processing device 100 of another data provider (here, the data provider DP2). As a specific example, the information processing device 100 of the data provider DP1 may specify, on the basis of the coordination setting, the data provider DP2 that is to next serve as an entity pertaining to executing the workflow after the information processing device 100 itself of the data provider DP1 executes the workflow. The information processing device 100 of the data provider DP1 may also specify, on the basis of the coordination setting, the contents of processing for coordinated operation with the information processing device 100 of the data provider DP2 as another data provider (e.g., a processing unit added to the workflow, etc.) for the workflow as an execution target.

In S313, on the basis of the analysis processing setting DAG1 received from the terminal device 200 of the data consumer DC1, the information processing device 100 of the data provider DP1 adds processing units corresponding to preprocessing and postprocessing to the workflow as an execution target. At this time, the information processing device 100 of the data provider DP1 may add, to the workflow, a processing unit for the coordinated operation with the information processing device 100 of the data provider DP2 as another data provider on the basis of the result of reading the coordination setting in S312. In the above manner, the workflow as an execution target is updated.

In S314, the information processing device 100 of the data provider DP1 executes the workflow corresponding to the analysis processing setting DAG1 and being updated in S313. As a specific example, the information processing device 100 may execute the workflow as a target on the basis of, for example, a container 310 corresponding to the analysis processing setting DAG1 that is retained in a container registry 330 managed by the terminal device 200.

Then, in S315, when the execution of the workflow as a target is completed, the information processing device 100 of the data provider DP1 notifies the terminal device 200 of the data consumer DC1 of the termination of the workflow. A result of executing the workflow is recorded in the container registry 330 managed by the terminal device 200. At this time, the information processing device 100 of the data provider DP1 may record data for subsequent coordinated operation by the information processing device 100 of the data provider DP2 as another data provider in the container registry 330 managed by the terminal device 200.

Next, in S316, the terminal device 200 of the data consumer DC1 generates an analysis processing setting DAG2 of the workflow as an execution target of the information processing device 100 of the data provider DP2. It is assumed here that the terminal device 200 generates an analysis processing setting DAG2 of the workflow executed by the information processing device 100 of the data provider DP2 in collaboration with the information processing device 100 of the data provider DP1. Subsequently, the terminal device 200 transmits the generated analysis processing setting DAG2 to the information processing device 100 of the data provider DP2.

In S317, when receiving the analysis processing setting DAG2 from the terminal device 200 of the data consumer DC1, the information processing device 100 of the data provider DP2 reads the coordination setting on the basis of the notification from the terminal device 200. On the basis of a result of reading the coordination setting, the information processing device 100 of the data provider DP2 specifies a setting and processing pertaining to the collaboration with an information processing device 100 of another data provider (here, the data provider DP1). Thus, for example, it is also possible for the information processing device 100 of the data provider DP2 to recognize that the information processing device 100 is to execute the workflow defined by the analysis processing setting DAG2 on the basis of a result of executing the workflow by the information processing device 100 of the data provider DP1. The information processing device 100 of the data provider DP2 may also specify, on the basis of the coordination setting, the contents of processing for coordinated operation with the information processing device 100 of the data provider DP1 as another data provider (e.g., a processing unit added to the workflow, etc.) for the workflow as an execution target.

In S318, on the basis of the analysis processing setting DAG2 received from the terminal device 200 of the data consumer DC1, the information processing device 100 of the data provider DP2 adds processing units corresponding to preprocessing and postprocessing to the workflow as an execution target. At this time, the information processing device 100 of the data provider DP2 may add, to the workflow, a processing unit for the coordinated operation with the information processing device 100 of the data provider DP1 as another data provider on the basis of the result of reading the coordination setting in S317. In the above manner, the workflow as an execution target is updated.

In S319, the information processing device 100 of the data provider DP2 executes the workflow corresponding to the analysis processing setting DAG2 and being updated in S318. As a specific example, the information processing device 100 may execute the workflow as a target on the basis of, for example, a container 310 corresponding to the analysis processing setting DAG2 that is retained in the container registry 330 managed by the terminal device 200.

Then, in S320, when the execution of the workflow as a target is completed, the information processing device 100 of the data provider DP2 notifies the terminal device 200 of the data consumer DC1 of the termination of the workflow. A result of executing the workflow is recorded in the container registry 330 managed by the terminal device 200.

The example of the flow of the processing by the information processing system 1 according to the present modification has been described with reference to FIG. 10.

Next, as an example of the information processing system 1 according to the present modification, an example of a case where a plurality of data providers execute one workflow in coordination with one another will be described with a specific example.

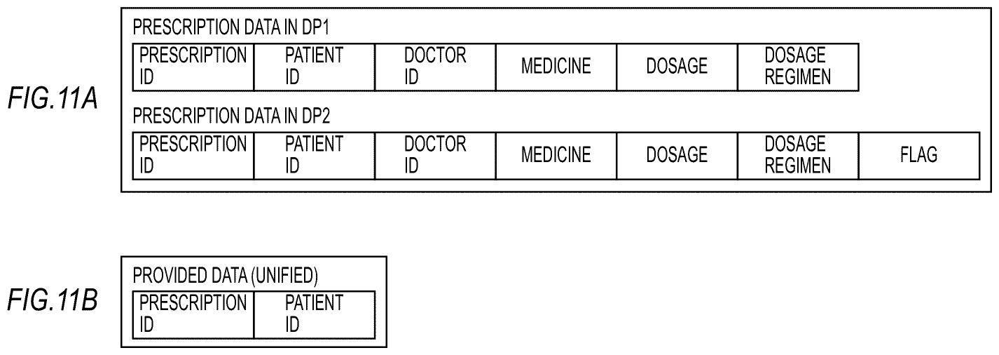

First, an example of a case where provision items in data as provision targets are unified between the data providers DP1 and DP2 will be described with reference to FIG. 11A and FIG. 11B. For example, FIG. 11A illustrates an example of structures of data items managed by the data providers DP1 and DP2. The example illustrated in FIG. 11A shows that provision items included in the data items managed by the data providers DP1 and DP2 partially differ from each other.

In such a configuration, the data items as provision targets may be unified between the data providers DP1 and DP2 by, for example, extracting, as targets, provision items that are included in the data items managed by the data providers DP1 and DP2 in common. For example, FIG. 11B illustrates an example of a data structure of a unified data item as a provision target.

As a specific example, in a case where information items corresponding to a patient ID and a medicine included in the data items of the data providers DP1 and DP2 in common are used as provision targets, for example, the patient ID and the medicine are preferably designated for the coordination setting as a range of provision items used as use targets.

On the basis of the coordination setting, the information processing device 100 of the data provider DP1 may add, to the workflow corresponding to the analysis processing setting DAG1, a processing unit that extracts information items corresponding to the provision items of the patient ID and the medicine from the data managed by the information processing device 100 itself to generate the data items as provision targets, as preprocessing of the main processing (e.g., analysis processing targeting the data). Similarly, on the basis of the coordination setting, the information processing device 100 of the data provider DP2 may add, to the workflow corresponding to the analysis processing setting DAG2, a processing unit that extracts information items corresponding to the provision items of the patient ID and the medicine from the data managed by the information processing device 100 itself to generate the data items as provision targets, as preprocessing of the main processing.

When the data items as provision targets are generated, the order of provision items constituting the data items as provision targets may be unified. In this case, it is only required to set, for the coordination setting, the order of provision items that are defined in the data items as provision targets. In addition, the information processing devices 100 of the data providers DP1 and DP2 are only required to add, to the workflow as an execution target, a processing unit pertaining to controlling the order of the provision items as preprocessing of the main processing (e.g., analysis processing targeting the data), in accordance with the coordination setting.

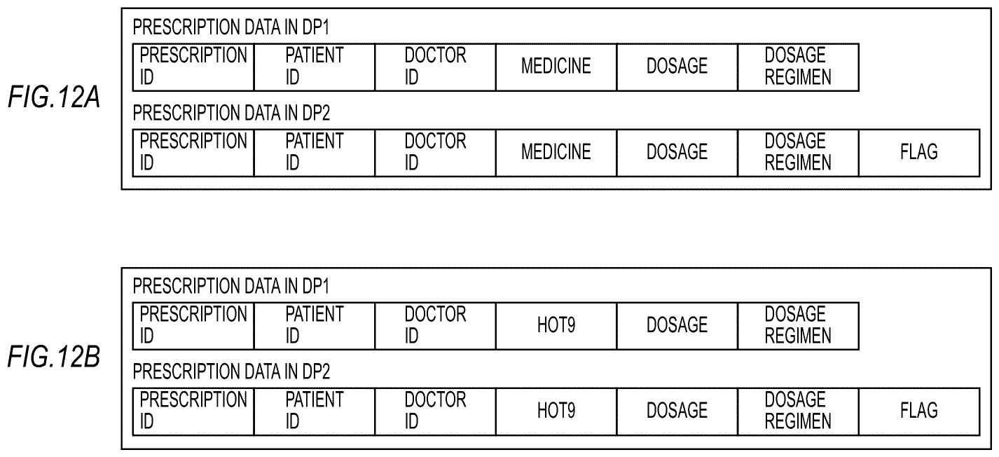

Next, an example of a case where codes that are set as information corresponding to at least one or some of provision items in data as a provision target are unified between the data providers DP1 and DP2 will be described with reference to FIG. 12A and FIG. 12B. For example, FIG. 12A illustrates an example of structures of data items managed by the data providers DP1 and DP2. In the example illustrated in FIG. 12A, peculiar information items for specifying medicines are set in the data providers DP1 and DP2.

In such a configuration, for example, processing for converting information items that are set to provision items corresponding to medicines in the data items managed by the data providers DP1 and DP2 into HOT reference codes (e.g., HOT9), which are standard codes denoting medicines, may be applied. For example, FIG. 12B illustrates an example of a data structure of data after the information items set to the provision items corresponding to the medicines are converted into the HOT reference codes, which are standard codes denoting medicines.

In this case, for example, the conversion of the information items set to the provision items corresponding to the medicines into the HOT reference codes, which are standard codes denoting medicines, is preferably designated for the coordination setting.

On the basis of the coordination setting, the information processing device 100 of the data provider DP1 may add, to the workflow corresponding to the analysis processing setting DAG1, a processing unit that converts the information item set to the provision item corresponding to the medicine in the data managed by the information processing device 100 itself into the HOT reference code, as preprocessing of the main processing (e.g., analysis processing targeting the data). Similarly, on the basis of the coordination setting, the information processing device 100 of the data provider DP2 may add, to the workflow corresponding to the analysis processing setting DAG2, a processing unit that converts the information item set to the provision item corresponding to the medicine in the data managed by the information processing device 100 itself into the HOT reference code, as preprocessing of the main processing (e.g., analysis processing targeting the data).

Note that the above is merely an example, and by using a coordination setting, any control applied to a plurality of institutions (stations) as coordination targets can be applied to information processing devices 100 of the plurality of institutions in common. As a specific example, it is also possible to achieve control of adding the cleansing processing, adding the pseudonymization or the anonymization, or the like, which has been described in the embodiment mentioned above.

As another example, a case where data output by the execution of a workflow by the information processing device 100 of the data provider DP1 (a result of executing one or some of processing units in the workflow) is used in processing by the information processing device 100 of the data provider DP2 as another data provider can also be assumed. In such a case, for example, the information processing device 100 of the data provider DP1 may add, to the workflow, as postprocessing of a processing unit (the main processing) that outputs data referred to by the information processing device 100 of the data provider DP2, a processing unit that causes the data to be retained in a region that can be referred to by the information processing device 100 of the data provider DP2.

As a specific example, the information processing device 100 of the data provider DP1 recognizes that data output by executing processing by the information processing device 100 itself is used by the information processing device 100 of the data provider DP2, by referring to a coordination setting as in the example mentioned above.

Subsequently, the information processing device 100 of the data provider DP1 adds, to a workflow corresponding to an analysis processing setting DAG1, as postprocessing of the main processing that outputs data as a target (e.g., a result of analysis processing), a processing unit that causes the data to be retained in a region that can be referred to by the information processing device 100 of the data provider DP2 (e.g., a container registry, etc.). As a more specific example, the information processing device 100 of the data provider DP1 adds, as the postprocessing, a processing unit that generates a container that can be referred to by the information processing device 100 of the data provider DP2, and designates, as parameters of the postprocessing, instructions pertaining to storing a result of the processing in the container and a location path of the container. In the above manner, the workflow as an execution target is updated.

The information processing device 100 of the data provider DP1 executes the updated workflow. Thus, a container is newly generated by the execution of the processing unit added to the workflow, and data as a target (e.g., a result of analysis processing) is stored in the container. Subsequently, the generated container is retained in a container registry 330 managed by a terminal device 200 of a data consumer DC1.

Note that information for accessing the newly generated container is only required to be shared between the information processing device 100 of the data provider DP1 and the information processing device 100 of the data provider DP2 by using, for example, a coordination setting.

Next, referring to the coordination setting as in the example mentioned above, the information processing device 100 of the data provider DP2 recognizes that the data output as the result of the processing executed by the information processing device 100 of the data provider DP1 is used in processing executed by the information processing device 100 itself of the data provider DP2. Referring to the coordination setting or the like, the information processing device 100 of the data provider DP2 reads the container storing the data as a target, that is, the container generated by the information processing device 100 of the data provider DP1.

Subsequently, when executing a workflow corresponding to an analysis processing setting DAG2, the information processing device 100 of the data provider DP2 applies the data stored in the read container (the result of the processing executed by the information processing device 100 of the data provider DP1).

By applying the above control, it is possible to achieve control under which a result of processing executed by one or some of institutions (stations) is applied to processing executed by another institution (station).

### CONCLUSION

As described above, the information processing device 100 according to the present embodiment receives, via a network, a request pertaining to executing a series of processes (e.g., a workflow) defined in such a manner that one or more first processing units are arranged to be sequentially executed. The information processing device 100 also updates the series of processes by adding a second processing unit based on the contents of the received request, to a timing based on the contents of the request in the series of processes. Subsequently, the information processing device 100 executes the updated series of processes.

With such a configuration, even under circumstances in which a method of managing data varies among a plurality of providers, it is possible to achieve remote utilization of the data in a preferable mode.

Note that the embodiment mentioned above is merely an example, does not necessarily limit the configuration and the processing according to the present invention, and may be subjected to various modifications and variations without departing from the technical idea of the present invention.

According to the present invention, it is possible to achieve, even under circumstances in which a method of managing data varies among a plurality of providers, remote utilization of the data in a preferable mode.

Furthermore, the following configurations also fall within the technical scope of the present disclosure.

(1) An information processing device comprising: a receiver configured to receive, via a network, a request pertaining to executing a series of processes defined in such a manner that one or more first processing units are arranged to be sequentially executed; an updater configured to update the series of processes by adding a second processing unit based on contents of the received request to a timing in the series of processes, the timing being based on the contents of the request; and a processor configured to execute the series of processes updated by the updater.

(2) The information processing device according to (1), wherein the updater specifies the timing in the series of processes and the second processing unit added to the series of processes, in accordance with to which of a requestee and a requester of the request data as a target of the series of processes belongs.

(3) The information processing device according to (2), wherein the updater adds, when the data as a target of the series of processes is data belonging to the requestee, the second processing unit that performs processing on at least part of the data to a timing in the series of processes, the timing being a timing before a timing of executing the first processing units targeting the data.

(4) The information processing device according to (2), wherein the updater adds, when the data as a target of the series of processes is data belonging to the requester, the second processing unit pertaining to examination targeting a result of executing the first processing units to a timing in the series of processes, the timing being a timing after a timing of executing the first processing units targeting the data.

(5) The information processing device according to any one of (1) to (4), wherein the updater adds, in accordance with a type of at least part of information included in data as a target of the series of processes, the second processing unit that performs processing on the at least part of information included in the data to a timing before a timing of executing the first processing units targeting the data.

(6) The information processing device according to (5), wherein the updater adds, when at least part of information included in the data as a target of the series of processes is of a type of information that is set as a concealment target, the second processing unit that performs processing pertaining to concealing the information included in the data, on the information, to a timing before a timing of executing the first processing units targeting the data.

(7) The information processing device according to any one of (1) to (6), wherein the updater adds, in accordance with a format of data as a target of the series of processes, the second processing unit that converts the format of the data to a timing before a timing of executing the first processing units targeting the data.

(8) The information processing device according to (7), wherein the updater adds, when the format of the data as a target of the series of processes is different from a predetermined format, the second processing unit that converts the format of the data into the predetermined format to a timing before a timing of executing the first processing units targeting the data.

(9) The information processing device according to any one of (1) to (8), wherein the updater adds, in accordance with a type of a code for specifying an object, the code being used in at least part of information included in data as a target of the series of processes, the second processing unit that converts the code to a timing before a timing of executing the first processing units targeting the data.

(10) The information processing device according to any one of (1) to (9), wherein the updater adds, in accordance with a state of data as a target of the series of processes, the second processing unit that performs cleansing processing on the data to a timing before a timing of executing the first processing units targeting the data.

(11) The information processing device according to any one of (1) to (10), wherein the updater adds, in accordance with a type of at least part of information included in data as a target of the series of processes, the second processing unit pertaining to examination targeting a result of executing the first processing units to a timing after a timing of executing the first processing units targeting the data.

(12) The information processing device according to any one of (1) to (11), wherein the updater adds, in accordance with a privilege of access that is set in data as a target of the series of processes, the second processing unit that changes the privilege of access to a timing before a timing of executing the first processing units targeting the data.

(13) The information processing device according to any one of (1) to (12), wherein the updater adds, in accordance with a privilege of access that is set in data as a target of the series of processes, the second processing unit that changes the privilege of access in accordance with a result of executing the first processing units to a timing after a timing of executing the first processing units targeting the data.

(14) The information processing device according to any one of (1) to (13), wherein the updater adds, when a result of executing at least one or some of the first processing units in the series of processes is used in processing by another information processing device, the second processing unit that causes the result of executing the first processing units to be retained in a region allowed to be referred to by the other information processing device, to a timing after a timing of executing the first processing units.

(15) An information processing method executed by a computer, the information processing method comprising: receiving, via a network, a request pertaining to executing a series of processes defined in such a manner that one or more first processing units are arranged to be sequentially executed; updating the series of processes by adding a second processing unit based on contents of the received request to a timing in the series of processes, the timing being based on the contents of the request; and executing the series of processes updated in the updating.

(16) A program for causing a computer to execute: receiving, via a network, a request pertaining to executing a series of processes defined in such a manner that one or more first processing units are arranged to be sequentially executed; updating the series of processes by adding a second processing unit based on contents of the received request to a timing in the series of processes, the timing being based on the contents of the request; and executing the series of processes updated in the updating.

What is claimed is:

1. An information processing device comprising:
a receiver configured to receive, via a network, a request pertaining to executing a series of processes defined in such a manner that one or more first processing units are arranged to be sequentially executed;
an updater configured to update the series of processes by adding a second processing unit based on contents of the received request to a timing in the series of processes, the timing being based on the contents of the request; and
a processor configured to execute the series of processes updated by the updater.

2. The information processing device according to claim 1, wherein the updater specifies the timing in the series of processes and the second processing unit added to the series of processes, in accordance with to which of a requestee and a requester of the request data as a target of the series of processes belongs.

3. The information processing device according to claim 2, wherein the updater adds, when the data as a target of the series of processes is data belonging to the requestee, the second processing unit that performs processing on at least part of the data to a timing in the series of processes, the timing being a timing before a timing of executing the first processing units targeting the data.

4. The information processing device according to claim 2, wherein the updater adds, when the data as a target of the series of processes is data belonging to the requester, the second processing unit pertaining to examination targeting a result of executing the first processing units to a timing in the series of processes, the timing being a timing after a timing of executing the first processing units targeting the data.

5. The information processing device according to claim 1, wherein the updater adds, in accordance with a type of at least part of information included in data as a target of the series of processes, the second processing unit that performs processing on the at least part of information included in the data to a timing before a timing of executing the first processing units targeting the data.

6. The information processing device according to claim 5, wherein the updater adds, when at least part of information included in the data as a target of the series of processes is of a type of information that is set as a concealment target, the second processing unit that performs processing pertaining to concealing the information included in the data, on the information, to a timing before a timing of executing the first processing units targeting the data.

7. The information processing device according to claim 1, wherein the updater adds, in accordance with a format of data as a target of the series of processes, the second processing unit that converts the format of the data to a timing before a timing of executing the first processing units targeting the data.

8. The information processing device according to claim 7, wherein the updater adds, when the format of the data as a target of the series of processes is different from a predetermined format, the second processing unit that converts the format of the data into the predetermined format to a timing before a timing of executing the first processing units targeting the data.

9. The information processing device according to claim 1, wherein the updater adds, in accordance with a type of a code for specifying an object, the code being used in at least part of information included in data as a target of the series of processes, the second processing unit that converts the code to a timing before a timing of executing the first processing units targeting the data.

10. The information processing device according to claim 1, wherein the updater adds, in accordance with a state of data as a target of the series of processes, the second processing unit that performs cleansing processing on the data to a timing before a timing of executing the first processing units targeting the data.

11. The information processing device according to claim 1, wherein the updater adds, in accordance with a type of at least part of information included in data as a target of the series of processes, the second processing unit pertaining to examination targeting a result of executing the first processing units to a timing after a timing of executing the first processing units targeting the data.

12. The information processing device according to claim 1, wherein the updater adds, in accordance with a privilege of access that is set in data as a target of the series of processes, the second processing unit that changes the privilege of access to a timing before a timing of executing the first processing units targeting the data.

13. The information processing device according to claim 1, wherein the updater adds, in accordance with a privilege of access that is set in data as a target of the series of processes, the second processing unit that changes the privilege of access in accordance with a result of executing the first processing units to a timing after a timing of executing the first processing units targeting the data.

14. The information processing device according to claim 1, wherein the updater adds, when a result of executing at least one or some of the first processing units in the series of processes is used in processing by another information processing device, the second processing unit that causes the result of executing the first processing units to be retained in a region allowed to be referred to by the other information processing device, to a timing after a timing of executing the first processing units.

15. An information processing method executed by a computer, the information processing method comprising:
receiving, via a network, a request pertaining to executing a series of processes defined in such a manner that one or more first processing units are arranged to be sequentially executed;
updating the series of processes by adding a second processing unit based on contents of the received request to a timing in the series of processes, the timing being based on the contents of the request; and
executing the series of processes updated in the updating.

16. A non-transitory computer-readable recording medium storing a program for causing a computer to execute:
receiving, via a network, a request pertaining to executing a series of processes defined in such a manner that one or more first processing units are arranged to be sequentially executed;
updating the series of processes by adding a second processing unit based on contents of the received request to a timing in the series of processes, the timing being based on the contents of the request; and
executing the series of processes updated in the updating.
